(19) United States
(12) Patent Application Publication
(10) Pub. No.: US 2015/0356602 A1
(43) Pub. Date: Dec. 10, 2015

(54) SYSTEMS AND METHODS FOR ADVERTISING

(71) Applicants: Brian MOORE, (US); Keith SENATOR, (US); Matthew MCCUTCHEN, (US)

(72) Inventors: Brian Moore, Stanwood, WA (US); Keith Senator, Covington, GA (US); Matthew McCutchen, Shoreline, WA (US)

(21) Appl. No.: 14/758,786

(22) PCT Filed: Jan. 3, 2014
(86) PCT No.: PCT/US2014/010252

§ 371 Date: Jun. 30, 2015

Related U.S. Application Data
(60) Provisional application No. 61/748,721, filed on Jan. 3, 2013.

(51) Int. Cl. G06Q 30/02

(52) U.S. Cl. CPC G06Q 30/0257

(57) ABSTRACT

Methods and systems are disclosed for interacting with advertisements via a display screen. The advertisement can be activated using an activation input, such as a gesture, a swiping motion, or other user interaction. The activation input can minimize, limit, or substantially prevent accidental activation of advertisements. Intentional activations of advertisements can be tracked to, for example, accurately determine appropriate payments to ad providers, collect user data, and/or other actions.

### CROSS REFERENCE TO RELATED APPLICATION

This application claims priority to U.S. Provisional Patent Application No. 61/748,721, filed on Jan. 3, 2013, and entitled, “SYSTEMS AND METHODS FOR ADVERTISING,” which is incorporated by reference herein in its entirety.

### BACKGROUND

Online advertising is the source of a huge amount of online traffic and revenue. Online advertisements are a nearly ubiquitous feature of our online experience because online advertisers typically advertise goods and services on or with websites, mobile apps, video games, set-top boxes, and so on. In many cases, advertisements may be targeted to users based on, for example, demographic information, online activities, search activities (e.g., search keywords used), online shopping activities, and so on. Online advertisements may take the form of pop-up advertisements, pop-under advertisements, banner advertisements, audio advertisements, video advertisements, animated gifs, and so on. Unfortunately, a user may accidentally click on or select advertisements. For example, users often accidentally activate advertisements displayed over or near a feature of a webpage or application with which the user wishes to interact.

Electronic devices (e.g., a smart phone, a tablet, etc.) with touch screens often display advertisements that can be activated. Unfortunately, individuals often accidentally activate the advertisements. For example, individuals with relatively large fingers may be prone to unintentionally activating the advertisements because the user's fingers may accidentally touch activation areas of the advertisements. Ad providers may be paid based on the number of advertisement activations. Accidental clicks or activations can result in excess revenue payments to the ad providers because it may be difficult to track intentional activation of ads.

### SUMMARY OF THE TECHNOLOGY

Systems and methods for activating advertisements and associated systems are disclosed herein. At least some embodiments are a computer-implemented method that includes displaying one or more advertisements on a display screen of an electronic device capable of detecting one or more activation inputs for selecting a specific advertisement. The user's selection of the advertisement is detected by the electronic device based on the activation inputs. An advertising action can be initiated based on the user's selection.

The activation inputs for interacting with advertisements can be selected to reduce or limit unintentionally activations by, for example, compensating for individuals with relatively large fingers. In some embodiments, the activation inputs for advertisements can be significantly different from inputs for interacting with activation areas or features of webpages or programs. Intentional interaction of the advertisements (e.g., intentional activation), if any, can be tracked to determine payment to, for example, ad provider(s). Unintentional interaction of the advertisements, if any, can be tracked to determine how to increase selection accuracy. The electronic device can include, without limitation, a smart phone, a tablet, laptop computer, or other computing device with one or more touch screens.

The advertising action, in some embodiments, can include launching a browser to direct the user to an advertiser's website, initiating buying an advertised product or service, opening a shopping cart, initiating a vote/survey response, displaying a next advertisement, and/or opening a full screen advertisement. Unintentional advertisement selection can be identified based on a user's response to the advertising action. The activation inputs can be refined based on user data, which can include, without limitation, past usage, user preferences, advertisement activation rate, or other data associated with the user. In some embodiments, the user data can include a user's indication (e.g., unintentional advertisement selection inputs) that unwanted initiation of the one or more advertising actions occurred. Accordingly, unintentional launching a browser directing the user to an advertiser's website, unintentional initiating buying an advertised product or service, unintentional opening a shopping cart, initiating a vote/survey response, unintentional displaying a next advertisement, and/or unintentional opening a full screen advertisement can be minimized or limited.

In some embodiments, a computer-implemented method for displaying advertisements on a display screen of an electronic device includes detecting a gesture-based selection of one or more advertisements displayed by the display screen based on gesture activation input. An advertising action is initiated based on the gesture-based selection of the advertisement(s). The gesture activation input can be altered based on a user response to the advertising action. The gesturing activation input can include, without limitation, multiple physical touches of the display screen (e.g., multiple contacts, multiple swipes, etc.), swipe gestures along the surface of the display screen, combinations thereof, and so on.

If gesture-based input from the user is sufficiently similar to target gesture-based activation input, the gesture-based input is identified as an intentional activation of the advertisement. The target gesture activation input can be refined by changing its characteristics, including geometry (e.g., the geometry of a target activation input corresponding to a geometric shape), dimensions, or the like. Target gesture activation input for activating advertisements can be refined by receiving gesture-based input, comparing the received gesture-based input to target gesture activation input, and refining the target gesture activation input based on the comparison. In some embodiments, the target gesture-based activation input is refined based on user preferences, user history, demographic information, online activities, search activities, online shopping activities, or other tracked data.

In some embodiments, a computer-readable storage medium stores instructions that, if executed by a computing system of an electronic device, cause the computing system to perform operations for displaying advertisements. The computing system can display one or more advertisements on a display screen of the electronic device capable of detecting one or more activation inputs for selecting a specific advertisement, associate one or more advertising actions with the one or more activation inputs, and identify selection of the specific advertisement by the user based on the one or more activation inputs.

In other embodiments, a computer-readable storage medium stores instructions that, if executed by a computing system, cause the computing system to perform operations for displaying advertisements on a display screen and receiving an indication that a user selected one or more advertisements displayed on the display screen based on a user gesture-based activation input via the display screen. In response to receiving the indication, an advertisement action associated with the selected advertisement (or advertisements) is initiated. The computing system can receive user confirmation input indicating whether the user selected advertisement associated with the initiated advertisement action. The computing system, in some embodiments, can include a computing device with the touch display screen. Exemplary computing devices can be mobile telephones, tablets, smart TVs, and other devices capable of displaying advertisements, programs, websites, and so on and may include memory, storage devices, media drives, processors, circuitry, and/or central processing units.

In some embodiments, an electronic device for displaying advertisements includes a display, memory configured to store instructions, and a central processing unit. The central processing unit receives instructions from the memory for displaying one or more advertisements and for detecting a gesture-based selection of one or more advertisements displayed. The detection of the gesture-based selection can be based on, without limitation, gesture activation inputs by the user. The electronic device can initiate an advertising action based on the gesture-based selection of the advertisements and can also refine the gesture activation input for interacting with the advertisement based on a user's response to an advertising action.

In further embodiments, an electronic device for displaying advertisements includes a means for displaying advertisements, means for storing one or more advertisements and instructions, and a central processing unit. The means for storing one or more advertisements and instructions can include memory (e.g., includes volatile memory, non-volatile memory, read-only memory, random access memory, or the like capable of storing instructions, information, data, or the like).

In further embodiments, a computing device can include a computing system with a display, memory configured to store instructions, and a central processing unit. In some embodiments, the computing device can include an electronic device in the form of a smart phone, a tablet, or a computer with a touch screen (e.g., a resistive touchscreen, capacitive sensing touchscreen, etc.) that may or may not provide haptic feedback.

In some embodiments, a user can interact with a displayed advertisement, a program, a website, and so on using redefinable activation inputs. For example, a user may be able to activate an advertisement/program by performing a swipe gesture or multiple touches. A swipe gesture or multiple touches can reduce the number unintentional “clicks”, thereby increasing the likelihood that activations/selections are intentional. The user can select a swipe gesture that activates advertisements/programs/website.

### BRIEF DESCRIPTION OF THE DRAWINGS

FIG. 1 is a block diagram illustrating an environment in which the disclosed techniques may operate.

FIG. 2 is a block diagram showing some of the components incorporated in associated computing systems.

FIG. 3 is a block diagram illustrating the processing of a user interaction component.

FIG. 4 illustrates a screenshot in accordance with certain embodiments of the present technology.

FIG. 5 illustrates a screenshot in accordance with certain embodiments of the present technology.

### DETAILED DESCRIPTION OF THE TECHNOLOGY

Systems and methods for activating advertisements and associated systems are disclosed herein. The systems can include a computing device with a touch screen. For example, the computing device can be a mobile device, such as a mobile telephone (e.g., a smart phone), a tablet, a smart TV, and other device capable of displaying advertisements. The advertisement can be activated using an activation input (e.g., a gesture, a swiping motion/gesture, or other user interaction). The activation input can be selected to minimize, limit, or substantially prevent accidental activation of advertisements. Intentional activations of advertisements can be tracked to, for example, accurately determine appropriate payments to ad providers, collect user data, etc.

By activating an advertisement, the user can be directed to one or more websites, applications, and/or files (e.g., media files, video files, or audio files) for or associated with, for example, the advertiser. Furthermore, the user may be able to perform other actions with respect to the advertisement, such as forwarding the advertisement to another user, saving the advertisement, “liking” or sharing the advertisement or associated advertiser (e.g., company) on a social networking site (e.g., FACEBOOK®, PINTEREST®, etc.), following the associated advertiser on a social network site (e.g., TWITTER®), by performing another input (e.g., a swipe gesture). In some embodiments, the advertisement can be activated be a gesture detected by the screen.

In some embodiments, the disclosed techniques may allow a user to interact with a displayed advertisement using one or more activation inputs. For example, a user may be able to activate an advertisement by performing a swipe gesture in a particular direction, such as up, down, to the left, or to the right. The swipe gesture can reduce the number unintentional “clicks” on the advertisement, thereby increasing the likelihood that activations of advertisements are intentional. In some embodiments, the gesture can correspond to one or more characters (e.g., letter, number, etc.), pictures, shapes, or other features that can be drawn on the touch screen by a stylus, a user's hand (e.g., using a finger), etc. For example, the gesture can include swiping a finger across at least a portion of the screen, drawing one or more characters on the screen, and so on. In other embodiments, the gesture can be a double-click (e.g., multiple touches on the display screen). The user can select the activation input. For example, the user can select a gesture that activates advertisements. In other embodiments, the computing device can select the activation input based on, for example, the type of advertisement, advertisement layout, advertisement size, or the like.

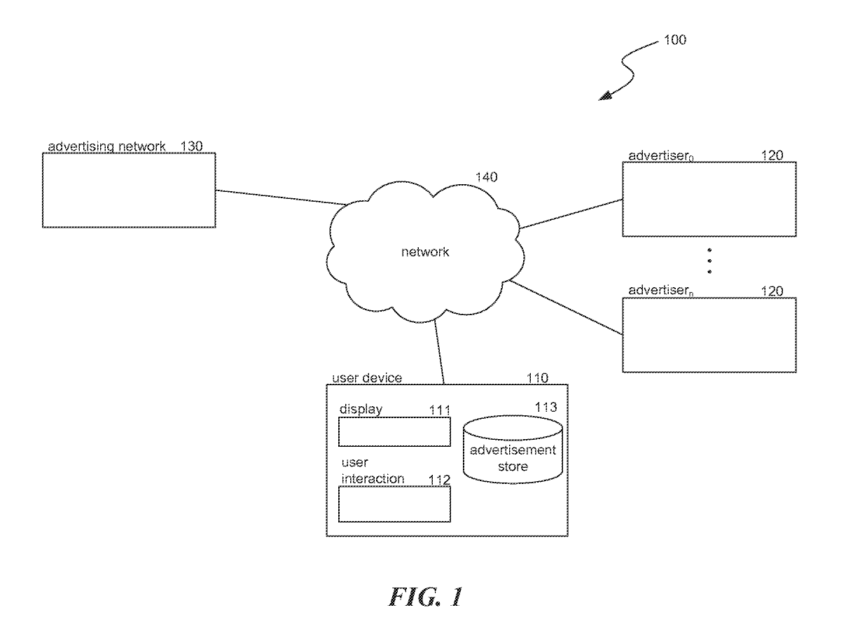

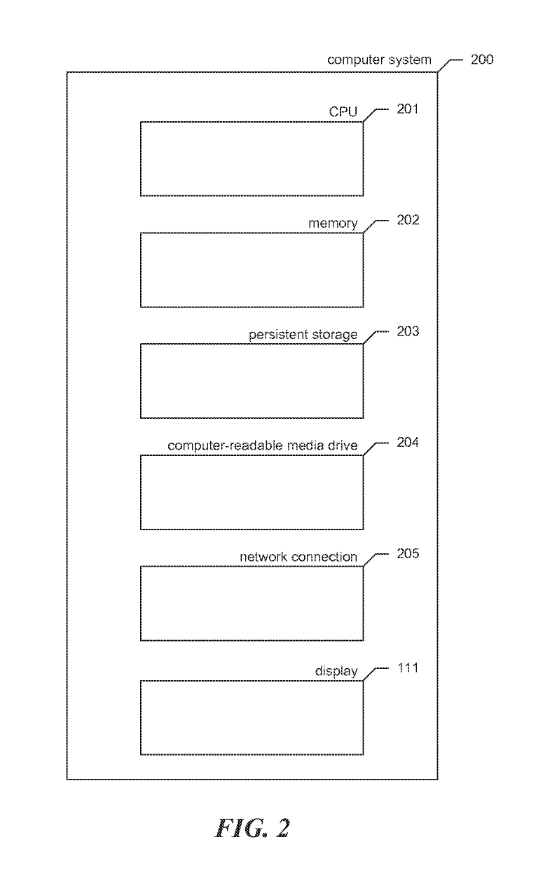

FIG. 1 is a block diagram illustrating an environment 100 in which the disclosed techniques may operate in some embodiments. In this example, environment 100 can include a user device 110, advertisers 120, advertising network 130, and network 140. User device 110 can be a computing device that includes a display 111, user interaction component 112, and advertisement store 113. In some embodiments, the device 110 include a computer system, such as the computer system discussed in connection with FIG. 2. Display 111 can be a touch screen display capable of detecting user input. User interaction 112 can be invoked to process user interactions with an advertisement displayed via the display 111. Exemplary user interaction 112 includes one or more activation inputs in the form of gesture-based inputs. Advertisement store 113 can store advertisements and associated information (e.g., number of times displayed, rate of display, time of day information for the advertisement, timeout duration, expiration date/time) received from advertisers 120, advertising network 130, etc. Advertisers 120 can represent companies or other entities that generate advertisements. Advertising network 130 can be a company or an entity that targets and distributes advertisements to users on behalf of advertisers based on, for example, geographic area (e.g., city location, country, etc.), time, user data, demographic information for the user, user preferences, and so on. In other embodiments, the advertising network 130 can be operated by a manufacture of the user device 110 or a distributor of the user device 110. User device 110, advertisers 120, and advertising network 130 can be connected and can communicate via network 140.

FIG. 2 is a block diagram showing some of the components incorporated in associated computing systems in some embodiments. Computer system 200 comprises one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable storage medium; and a network connection 205 for connecting the computer system to other computer systems, such as via the Internet. While computer systems configured as described above are suitable used to support the operation of the disclosed technology, those skilled in the art will appreciate that the techniques may be implemented using devices of various types and configurations. Moreover, communications to and from the CPU and on data buses and lines can be encrypted to protect against snooping of internal data.

The computing devices on which the disclosed techniques may be implemented can include a screen (e.g., display 111 of FIG. 1), a central processing unit, memory, input devices (e.g., keyboards, virtual keyboards, touchscreens, and pointing devices), output devices (e.g., display devices), and storage devices (e.g., disk drives). Central processing units can include one or more processor with circuitry for executing the instructions from memory. The memory and storage devices are computer-readable storage media that may be encoded with computer-executable instructions that implement the technology, which means a computer-readable storage medium that stores the instructions. In addition, the instructions, data structures, and message structures may be transmitted via a computer-readable transmission medium, such as a signal on a communications link. Thus, “computer-readable media” includes both computer-readable storage media for storing information and computer-readable transmission media for transmitting information. Additionally, data used by the disclosed techniques may be encrypted. Various communications links may be used, such as the Internet, a local area network, a wide area network, a point-to-point dial-up connection, a cell phone network, wireless networks, and so on. Exemplary computing devices include, without limitation, mobile telephones, tablets, smart TVs, computers with touch screens, or the like and can include an operating system (e.g., iOS, Android® Operating System, Blackberry operating system, or Microsoft Windows® operating system).

Referring to FIG. 2, memory 202 may store computer-executable instructions, such as program modules, executed by one or more computers or other devices. Generally, program modules can include routines, programs, objects, components, data structures, and so on that perform particular tasks or implement particular abstract data types. Typically, the functionality of the program modules may be combined or distributed as desired in various embodiments, including cloud-based implementations. The memory 202, in some embodiments, includes volatile memory, non-volatile memory, read-only memory (ROM), random access memory (RAM), or the like capable of storing instructions, information, data, or the like.

Many embodiments of the technology described herein may take the form of computer-executable instructions, including routines executed by a programmable computer. The computer executable instructions may cause activation of advertisements based, at least in part, on activation input. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

The technology can also be practiced in distributed environments, where tasks or modules are performed by remote processing devices linked through a communications network. In a distributed computing environment, program modules or subroutines may be located in local and remote memory storage devices. Aspects of the technology described herein may be stored or distributed on computer-readable media, including magnetic or optically readable or removable computer disks. Furthermore, aspects of the technology may be distributed electronically over networks. Data structures and transmissions of data particular to aspects of the technology are also encompassed within the scope of the technology.

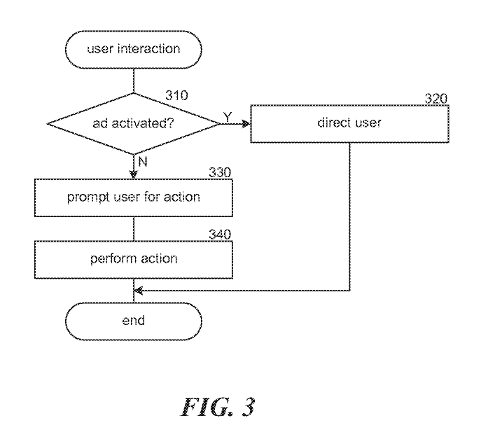

FIG. 3 is a block diagram illustrating the processing of a user interaction component in some embodiments. Generally, a computing device can process the user interaction component (e.g., one or more user inputs) to accurately initiate advertisements in order to minimize, limit, or substantially eliminate unintentional activation of advertisements. The computing device can detect gesture-based selection of displayed advertisements based on gesture activation input by the user. The computing device can initiate an advertising action based on the gesture-based selection. User interaction components can be analyzed to minimize, limit, or substantially eliminate unintentional activation of advertisements by refining target gesture activation input. Details of processing the user interaction component are discussed below.

In decision block 310, if the user interaction is an activation of the advertisement, then the component continues at block 320, else the component continues at block 330. For example, the component may be configured to detect certain activation inputs with respect to the advertisement as “activations,” or an interest to view more information associated with the advertisement, and other actions or gestures (e.g., swipe to the left) as non-activation interaction as selection of the advertisement but no present interest in following the advertisement. The user activations can be gesture-based inputs that are selected by, for example, the user, the computing device, and/or advertiser.

In block 320, one or more advertising actions are performed. In some embodiments, the advertising action includes directing the user to a site, location, or media file associated with the advertisement, such as a website, mobile application, video, audio recording, etc. For example, the component may display a video over a virtual keyboard or in place of an advertisement displayed with the virtual keyboard. As another example, the component may launch a browser directing the user to the advertiser's website. Alternatively, the component may initiate a “buy now” command for an advertised product or service, open a shopping cart, initiate a vote or survey response, open a full screen advertisement, and so on. In some examples, the component may prompt the user to select an action to take with respect to the advertisement. Different advertising actions can be associated with different activation inputs. One activation input can be a gesture corresponding to a letter for launching one or more browsers. Another activation input can be a gesture corresponding to a number for opening a shopping cart. The association between the advertising actions and activation inputs can be selected by the user or the computing device, or both.

In block 330, the component prompts the user for an action, such as saving the advertisement for later use, forwarding the advertisement to another user, liking or sharing the advertisement or advertiser on a social networking site, etc. In some embodiments, the component prompts the user for confirmation of the selection of the advertisement.

In block 340, the component performs an action selected by the user and then completes the action. Actions in response to a user interaction with an advertisement may include, for example, initiating an advertisement action, including opening an advertisement in another window, activating an ad in a window of a messaging screen, morphing the advertisement to a video or an image, claiming a product or a prize, ordering or bidding on a good or service, entering a raffle or drawing, printing a coupon, “liking” a tv show, voting for a contestant (e.g., Dancing with the Stars, America's Got Talent, X Factor), reporting ratings for television programs, purchasing a product via a website, such as Groupon, Living Social, etc. and so on. In some cases, an advertisement may be static such that user interactions with the advertisements are ignored, although the user interaction are tracked. Advertisements can be selected based on the tracked data.

In block 340, if the user indicates that an unintentional or unwanted action is performed, the computing device can alter the activation inputs. Data can be tracked and used to continuously or periodically refine the activation inputs. Refining the activation inputs can include removing activation inputs, altering activation inputs, and/or adding activation inputs. As such, the set of activation inputs can be increased, decreased, or otherwise altered to reduce, minimize, limit, or substantially eliminate unintentional activation of advertisements. In user refined embodiments, the user can select gestures that tend to eliminate unintentional activation of advertisements for removal. In automated refined embodiments, the computing device can remove gestures that the computing device determines resulted in unintentional activation of advertisements.

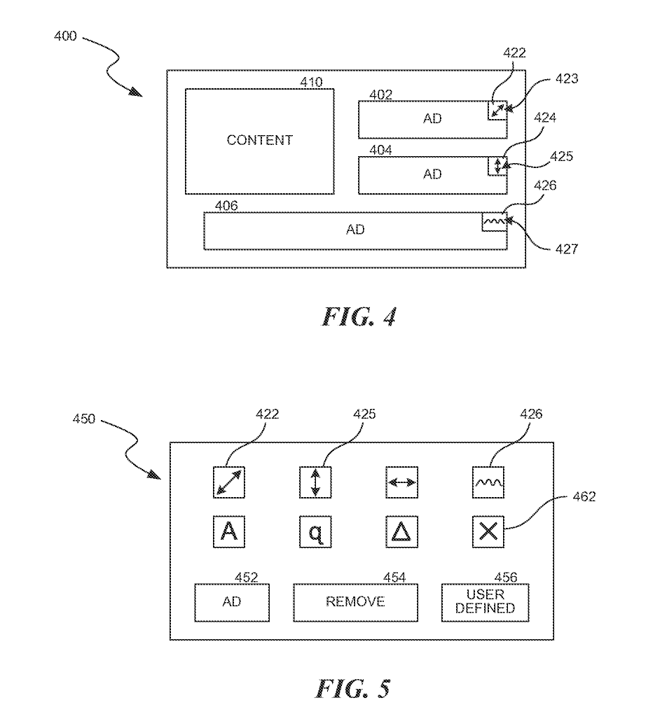

FIG. 4 is a depiction of a screenshot 400 that includes advertisements 402, 404, 406 and non-advertisement content 410. The advertisement 402 can include an activation feature 422 indicating activation input in the form of gesture-based user input 423. The illustrated gesture-based input is diagonally oriented arrows indicating that the user can swipe their finger diagonally across the screen to select the advertisement 402. In one embodiment, the swiping gesture has to be over advertisement 402 and/or the activation feature 422 to interact with the advertisement 402. In other embodiments, the swiping gesture can be performed at other locations along the screen display. The advertisement 404 can include an activation feature 424 indicating gesture-based user input 425, illustrated as an up and down swipe gesture. The advertisement 406 can include an activation feature 426 indicating the gesture-based user input 427, illustrated as a predetermined serpentine swipe gesture. Thus, each advertisement can have a unique gesture to avoid unintentional selection of the advertisements 402, 404, 406. The activation inputs for interacting with advertisements can be different from actions (e.g., inputs) used to interact with programs or webpages over or near the advertisements. As such, a user can interact with features of the content 410 of FIG. 4 without activating advertisements.

The user can change the gesture-based input. FIG. 5 is a depiction of a screenshot 450 for changing activation input. A user can select an add button 452 to add activation features/inputs, a remove button 454 to remove activation features/inputs, and a user defined button 456 to define activation features/inputs. By way of example, if the user unintentionally activates the advertisement 402 in FIG. 4, the user can select the remove button 454 of FIG. 5 and then select the activation feature 422 for removal. The advertisement 402 can be displayed with another activation features selected by user using the add button 452. For example, the user can add activation feature 462 (illustrating a X shaped gesture) of FIG. 5 to the advertisement 402 of FIG. 4. In other embodiments, the computing device determines the activation inputs for selecting corresponding advertisements based on detected user gestures to enhance accuracy.

The characteristics of the gestures can be selected to enhance accuracy. For example, the minimum length or distance of swipe gestures can be increased to increase accuracy. For example, the gesture length (e.g., length drawn on the display screen) can be equal to or greater than about 2 mm, 4 mm, 5 mm, 10 mm, or any other desired length. The length or distance of the gesture can be decreased to increase activation speed (e.g., decrease total time required to activate an advertisement). User preferences may often vary between users and such preferences can be stored for retrieval. The computing can select the user preferences to determine how to operate advertisements.

The embodiments disclosed herein can be used to display a wide range of advertisements (e.g., logos, text, graphics, images, etc.) or other information (e.g., information about operation of the user device). Exemplary advertisements include, without limitation, pop-up advertisements, pop-under advertisements, banner advertisements, audio advertisements, video advertisements, animated gifs, and so on and can have, without limitation, one or more inactive areas and one or more active areas (e.g., a button, an activation icon, etc.) corresponding to an area for detecting activation input. A user can contact the inactive area (e.g., area 410 in FIG. 4) without activating the advertisement. The advertisements can be displayed continuously or at intervals (e.g., preset intervals, user defined intervals, intervals determined based on user input, etc.). Data can be collected and analyzed. At least one embodiment can include collecting data via the other user input, number of ads activated, types of activated ads, etc. Displaying of advertisements can be controlled based on the data. For example, the user device could cycle through numerous advertisements while a user composes a text message, an email, or the like. Additionally, the collected data (e.g., number of intentional activations, number of unintentional activations, etc.) can be used to more accurately target users with advertisements and can capture analytics across multiple platforms and devices. The gesture-based activation can be selected based on the data.

The various embodiments described herein may also be combined to provide further embodiments and features from various embodiments can be combined with features and methods disclosed in U.S. application Ser. No. 13/842,617, U.S. App. No. 61/748,718, U.S. App. No. 61/748,721, which are incorporated by reference in their entireties. For example, gesture-based advertisement activation discussed herein can be combined with virtual keyboards or other embodiments disclosed in U.S. application Ser. No. 13/842,617. The detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes or blocks are presented in a given order, alternative embodiments may perform routines having steps, or employ systems having blocks, in a different order, and some processes or blocks (e.g., blocks discussed in connection with FIG. 3) may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times to minimize, limit, or substantially prevent accidental activation of advertisements, programs, and/or websites, for example. Intentional activations and/or unintentional activations of advertisements, advertisements, programs, and/or websites can be tracked to, for example, accurately determine appropriate payments to ad providers, collect user data, program usage, or the like. As such, the teachings of the described technology provided herein can be applied to other systems, not necessarily the system described herein. The elements and acts of the various embodiments described herein can be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. While the above description details certain embodiments of the technology and describes the best mode contemplated, no matter how detailed the above appears in text, the described technology can be practiced in many ways. The described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

What is claimed is:

1. A computer-implemented method for displaying advertisements, comprising:
displaying one or more advertisements on a display screen of an electronic device capable of detecting one or more activation inputs for selecting a specific advertisement of the one or more advertisements, wherein the one or more activation inputs include at least one of a swipe gesture along the display screen or multiple touches of the display screen;
detecting the one or more activation inputs;
identifying selection of the specific advertisement by the user based on detection of the one or more activation inputs; and
initiating one or more advertising actions associated with the selection of the specific advertisement.

2. The computer-implemented method of claim 1, further comprising:
after initiating the one or more advertising actions, identifying unintentional advertisement selection based on user data associated with the user's response to at least one of the advertising actions; and
refining the one or more activation inputs for selecting the specific advertisement based on the identification of the unintentional advertisement selection.

3. The computer-implemented method of claim 2, wherein the user data includes an unintentional activation input from the user.

4. The computer-implemented method of claim 1, further comprising:
prior to identifying the selection of the specific advertisement by the user, selecting the one or more advertising actions; and
associating the one or more advertising actions with the one or more activation inputs.

5. The computer-implemented method of claim 1, further comprising determining the one or more activation inputs based on an advertisement type of the specific advertisement, a layout of the specific advertisement, and/or a size of the specific advertisement.

6. The computer-implemented method of claim 1, wherein the swipe gesture corresponds to one or more letters, numbers, and/or predetermined shapes drawn on the display screen.

7. The computer-implemented method of claim 1, wherein the multiple touches include repeated physical contact of the display screen by the user's hand.

8. The computer-implemented method of claim 1, further comprising:
determining whether the user intentionally selected the specific advertisement; and
refining the one or more activation inputs based on the determination of whether the user intentionally selected the specific advertisement.

9. The computer-implemented method of claim 1, further comprising:
receiving one or more unintentional advertisement selection inputs;
associating the one or more unintentional advertisement selection inputs with the initiation of the one or more advertising actions; and
determining whether the user intentionally selected the specific advertisement based on the association of the one or more unintentional advertisement selection inputs with the initiation of the one or more advertising actions.

10. The computer-implemented method of claim 1, further comprising determining the one or more activation inputs based on user input detected by the electronic device.

11. The computer-implemented method of claim 1, wherein the one or more advertising actions include displaying additional advertisements on the display screen.

12. The computer-implemented method of claim 1, wherein the one or more advertising actions include at least one of launching a browser directing the user to an advertiser's website, initiating buying an advertised product and/or an advertised service, opening a shopping cart, initiating a vote/survey response, or opening a full screen advertisement.

13. The computer-implemented method of claim 1, wherein identifying the selection of the specific advertisement includes determining whether user input corresponds to the one or more activation inputs.

14. The computer-implemented method of claim 1, wherein initiating the one or more advertising actions includes displaying a targeted advertisement.

15. The computer-implemented method of claim 1, wherein displaying the one or more advertisements on the display screen includes:
displaying the specific advertisement; and
displaying a next advertisement of the one or more advertisements based on the selection of the specific advertisement.

16. The computer-implemented method of claim 1, further comprising:
displaying one or more gesture-based user inputs;
detecting selection of at least one of the gesture-based user inputs by the user; and
associating the selected gesture-based user inputs with the one or more activation inputs.

17. The computer-implemented method of claim 1, wherein the one or more activation inputs are gesture-based user inputs.

18. A computer-implemented method for displaying advertisements on a display screen of an electronic device, comprising:
detecting a gesture-based selection of one or more advertisements displayed by the display screen based on gesture activation input;
initiating an advertising action based on the gesture-based selection of the one or more advertisements on the display screen; and
refining the gesture activation input based on a user's response to the advertising action.

19. The computer-implemented method of claim 18, wherein detecting the gesture-based selection of one or more advertisements includes:
displaying one or more advertisements on the display screen;
identifying one or more advertising actions to associate with one or more gesture activation inputs; and
associating one or more advertising actions with the one or more gesture activation inputs.

20. The computer-implemented method of claim 18, wherein refining the gesture activation input includes:
receiving gesture-based input;
comparing the gesture-based input to the gesture activation input associated with the gesture-based selection; and
refining the gesture activation input based on the comparison.

21. A computer-readable storage medium storing instructions that, if executed by a computing system, cause the computing system to perform operations comprising:
displaying an advertisement on a display screen;
receiving an indication of selection of the advertisement displayed on the display screen based on a user gesture activation input;
in response to receiving the indication, initiating an advertisement action associated with the selected advertisement; and
receiving a user confirmation indicator indicating whether the user intentionally selected the advertisement associated with the initiated advertisement action.

22. The computer-readable storage medium of claim 21, further comprising detecting selection of the advertisement by the user based on the user gesture activation input via the display screen.

23. The computer-readable storage medium of claim 21, further comprising:
after initiating the advertisement action associated with the selected advertisement, determining unintentional advertisement selection based on user data associated with the advertisement action; and
determining gesture activation inputs for selecting future advertisements based on user data.

24. An electronic device for displaying advertisements, comprising:
a display;
memory configured to store instructions; and
a central processing unit (CPU) that receives instructions from the memory for display one or more advertisements and to:
detect gesture-based selection of the one or more advertisements displayed by the display based on gesture activation input,
initiate an advertising action based on the gesture-based selection of the one or more advertisements on the display, and
determine the gesture activation input based on a user response to the advertising action.

25. The electronic device of claim 24, wherein the CPU is configured to execute the instructions to perform the method as in any one of claims 1-20.

26. The electronic device of claim 24, wherein the memory stores instructions for performing the method as in any one of claims 1-20.
